(19) United States
(12) Patent Application Publication
(10) Pub. No.: US 2003/0199611 A1
(43) Pub. Date: Oct. 23, 2003

(54) Inkjet ink for textiles

(76) Inventors: Casey K. Chandrasekaran, Kennett Square, PA (US); Ali Ahmed, Hockessin, DE (US); Thomas E. Henzler, West Chester, PA (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/382,153

(22) Filed: Mar. 5, 2003

Related U.S. Application Data
(60) Provisional application No. 60/362,603, filed on Mar. 8, 2002.

(51) Int. Cl. C03C 17/00; C09D 5/00

(52) U.S. Cl. 523/160; 523/161

(57) ABSTRACT

This invention pertains to an aqueous inkjet ink with soluble colorant and polypropylene glycol which is especially suitable for printing of textiles.

### CROSS-REFERENCE TO RELATED APPLICATION

This application claims priority under 35 U.S.C. §119 from U.S. Provisional Application Serial No. 60/362,603 (filed Mar. 8, 2002), which is incorporated by reference herein as if fully set forth.

### FIELD OF THE INVENTION

This invention pertains to an aqueous inkjet ink with soluble colorant which is especially suitable for printing of textiles.

### BACKGROUND OF THE INVENTION

Digital printing methods such as inkjet printing are becoming increasingly important for the printing of textiles and offer a number of potential benefits over conventional printing methods such as screen printing. Digital printing eliminates the set up expense associated with screen preparation and can potentially enable cost effective short run production. Inkjet printing furthermore allows visual effects such as tonal gradients and infinite pattern repeat sizes which can not be practically achieved with a screen printing process.

However, inkjet printing as it exists today suffers from relatively slow speed. To be competitive with screen printing even for short runs, the speed of inkjet printers needs to increase. One means for increasing speed is to develop larger ‘industrial’ printheads having a greater number of nozzles which are compatible with aqueous ink. Such heads have recently become available from companies such as Spectra Inc. (Hanover, N.H. USA) and Hitachi Koki Imaging Solutions (Simi Valley, Calif. USA). Previously, heads of this sort were only available for solvent inks and were not suitable for jetting aqueous inks.

Printers adapted to use these aqueous compatible industrial printheads are being developed and are becoming commercially available.

Industrial heads generally require higher viscosity inks, for example, in the range of 8 to 20 cps at 25° C., as opposed to lighter duty heads which generally have an upper viscosity limit of about 5 cps.

Aqueous based inkjet ink formulations with soluble colorants, such as dyes, tend to be inherently low in viscosity. Deliberate measures must be taken to make the ink higher in viscosity. However, the means by which higher viscosity is achieved is a significant factor in the success of the ink formulation.

U.S. Pat. No. 5,250,121 discloses aqueous inkjet inks for textiles comprising reactive dye, thiodiglycol and at least one solvent selected from di-, tri- and tetramers of ethlene glycol or propylene glycol.

U.S. Pat. No. 6,015,454 discloses aqueous inkjet inks for textiles comprising certain reactive dyes and propylene glycol or n-methylpyrrolidone.

EP-A-1010802 discloses inkjet inks for textiles comprising reactive dyes, water, surfactant and at least one ethoxylated or propoxylated glycerine.

All of the above publications are incorporated by reference herein for all purposes as if fully set forth.

There is still need in the art for aqueous based inkjet inks with soluble colorant which are suitable for use with textiles and which are adaptable for use in printing systems where higher viscosity is needed. It is an objective of this invention to provide such compositions.

### SUMMARY OF THE INVENTION

It was found that polypropylene glycol was surprisingly effective as a viscosity modifying agent for aqueous inkjet inks, especially inks for textile comprising soluble dye. Other common viscosity agents had deleterious effects on jetting and/or color development.

In accord with these findings, there is provided an inkjet ink composition having a desired viscosity up to about 30 cps at 25° C., said inkjet ink comprising a soluble colorant, at least about 40% water (based on the total weight of the ink), and a polypopylene glycol of number average molecular weight (Mn) in the range of about 425 to less than 2000, wherein the amount of said polypropylene glycol in said inkjet ink is effective to impart said desired viscosity.

“Desired viscosity” refers to the viscosity of the ink as formulated. The amount of polypropylene glycol “effective to impart said desired viscosity” refers to the amount of polypropylene glycol required to be added to the ink formulation in order to raise the viscosity of the formulated ink to the desired viscosity.

The colorant is preferably one or more dyes, and more preferably one or more reactive dyes.

There is also provided a method of inkjet printing comprising printing a textile substrate with an inkjet printer by jetting one or more inkjet inks via said inkjet printer onto said textile substrate, wherein at least one of said one or more inkjet inks is the aforementioned inventive ink.

These and other features and advantages of the present invention will be more readily understood by those of ordinary skill in the art from a reading of the following detailed description. It is to be appreciated that certain features of the invention which are, for clarity, described above and below in the context of separate embodiments, may also be provided in combination in a single embodiment. Conversely, various features of the invention which are, for brevity, described in the context of a single embodiment, may also be provided separately or in any subcombination.

### DETAILED DESCRIPTION OF THE PREFERRED EMBODIMENTS

The aqueous inks of the present invention are comprised primarily of water. Thus the instant inks comprise at least about 40%, preferably at least about 45%, and even more preferably at least about 50% by weight of water.

The instant inks further comprise a soluble colorant, preferably a soluble dye, more preferably a soluble dye suitable for use on textile. Preferred dyes include reactive dyes, in particular monochlorotriazine, dichlorotriazine and vinyl sulfone classes of reactive dyes.

Dyes, as received, typically contain substantial amounts of salt. It is advantageous, from the point of view of jetting performance, to reduce the salt content to low levels. Techniques for salt removal, such as membrane filtration (ultrafiltration and/or nanofiltration), are well known for inkjet inks—see for example U.S. Pat. No. 4,373,954 and U.S. Pat. No. 5,262,054 (which are incorporated herein by reference for all purposes as if fully set forth).

The instant inks further comprise polypropylene glycol (PPG) to modify (increase) viscosity. PPG is an oligomeric condensation product of 1,2-propanediol (propylene glycol). Preferably the number average molecular weight (Mn) of the PPG is in the range of about 425 (about 7 propylene glycol units) to about 1000 (about 17 propylene glycol units). At lower molecular weight PPG, there is insufficient viscosity build and at higher molecular weight PPG (e.g. Mn of 2000 or above) there is phase separation.

The PPG will be present in an amount required to achieve the desired viscosity (effective to impart said desired viscosity). In other words, based upon a target viscosity (desired viscosity), one skilled in the art can readily determine, by straightforward methods and without undue experimentation, the amount of PPG required (in a given ink formulation) to achieve that target viscosity.

Preferably, the ink is formulated to have a viscosity such that the PPG is present in the ink at about 5% by weight or more, preferably at least about 8% and most preferably at least about 10% by weight, based upon the total ink weight. The person of ordinary skill in the art will appreciate that higher viscosity is achieved by use of higher levels of and/or higher molecular weight PPG. Given the teachings herein, routine optimization will reveal the best combination of weight percent and molecular weight for a given situation.

The ink viscosity at 25° C. will generally be up to about 30 cps, preferably in the range of about 5 cps to about 30 cps, and more typically in a range of about 8 cps to about 20 cps. A particularly preferred viscosity range, from the standpoint of jetting performance in currently available industrial printheads, is about 10 cps to about 16 cps.

Co-solvent(s) may optionally be added. The co-solvent can help improve the compatibility/solubility of the ink ingredients and improve jetting performance. Useful co-solvents include: mono-, di- and tri-ethylene glycol; mono-, di- and tripropylene glycol; mono- and di-C₁-C₄-alkyl ethers of the foregoing glycols; glycerol; 2-pyrrolidone; N-methyl pyrrolidone; aromatic and aliphatic alcohols; and, esters.

The ink may also contain other ingredients as are well known in the art. For example, anionic, nonionic, or amphoteric surfactants may be used. In aqueous inks, the surfactants are typically present in the amount of about 0.01-5% and preferably about 0.2-2%, based on the total weight of the ink.

Biocides such as Proxel GXL may be used to inhibit growth of microorganisms.

Sequestering agents such as EDTA may also be included to eliminate deleterious effects of heavy metal impurities.

Other known additives may also be added to improve various properties of the ink compositions as desired.

Preferably, however, the inks are substantially free of polyethylene glycols (PEG) because, as shown in the examples below, these seem to have a deleterious effect on shade depth.

The inks of this invention are advantageously used to print textiles. Textiles include but are not limited to cotton, wool, silk, nylon, polyester and the like, and blends thereof. The finished form of the textile includes, but is not limited to, fabrics, garments, furnishings such as carpets and upholstery fabrics, and the like.

It is common, but not always necessary, to pre-treat a textile prior printing in order to provide better color development and/or fixation. Such techniques are well known in the field of textile coloring.

Also commonly, but not necessarily, a printed textile will be subjected to post treatment to fix the ink to the textile. The post treatment may include heat or steam treatment. Again, such techniques are well known.

The following examples are intended to more fully illustrate, but not limit, the invention.

### EXAMPLES

Ingredients

The following materials were obtained from Aldrich (Milwaukee, Wis.): PPG 425 (polypropylene glycol, Mn 425); PPG 1000 (polypropylene glycol, Mn 1000); PEG 4600 (polyethylene glycol, Mn 4600); PEG 900 (polyethylene glycol, Mn 900); PEG 600 (polyethylene glycol, Mn 600); PEG/PPG Copolymer Mw 8400 (polyethylene glycol-block-polypropylene glycol-block-polyethylene glycol, Mn 8400); PEG/PPG copolymer Mw 12000 (polyethylene glycol-random-propylene glycol, Mn 12000).

The following are from The Dow Chemical Co. (Midland, Ml): Dowanol™ DPM (dipropylene glycol monomethyl ether), Dowanol™ TPM (tripropylene glycol monomethyl ether), Dowanol™ DMM (dipropylene glycol dimethyl ether) and Dowanol™ PnP (dipropylene glycol mono-n-propyl ether).

The Procion® and Jettex® dyes are from Dystar (Frankfurt, Germany); the Cibacron® dyes are from Ciba Specialty Chemicals (Basel, Switzerland); the Black GR is from Avecia (Wilmington, Del. USA), and the Foureactive Blue P-BR is from Four Color, Inc. (Dalton, Ga. USA).

Preparation of Inks

The inks were made by stirring the ingredients in a plastic container until uniform. Inks which were jetted were purified by membrane filtration (ultrafiltration and/or nanofiltration) to reduce chlorides, sulfates and phosphates, and filtered (1 micron polypropylene filter). Viscosity was in the range of 10-16 cps, at 25° C. (Brookfield viscometer) for all samples.

Preparation of Samples and Color Measurements

The fabric used for all samples was 100% cotton (Style 419 from Testfabrics Inc, West Pittston, Pa.) pre- and post-treated as described herein after. Color coordinates were measured according to AATCC Procedure 6 for instrumental color measurement (equivalent to ISO Procedure#105-J01).

A Minolta Spectrophotometer model CM3600D was used with D65 illuminant and 10 degree observer, specular-included. Samples were folded to confirm the opacity of the printed surface. L*, a*, b*, c, and h values were directly read by the spectrophotometer using the software supplied by the manufacturer. Color strength (K/S, also referred to as shade depth) value was also obtained directly from the spectrophotometer as calculated by the software.

Fabric Pretreatment

The cotton fabrics were pretreated with a solution comprised of (weight percent): Dialgin HV (sodium alginate type thickener from B. F. Goodrich), 2%; urea, 8%; sodium chloride, 6%; sodium bicarbonate, 6%; sodium carbonate, 1%; and water (balance). Viscosity of the pretreatment solution was approximately 620 cps at 25° C. (Brookfield viscometer) and the pH was 8.7.

The pretreated solution was applied by pad to the fabric. The wet pick up from the padder was at 75-80%, which would be equivalent to 18-20% dry pick up on the weight of the fabric. The pretreated fabric was dried with a Stenter Frame at 75-80° C. and a speed of 15 yards per minute.

Post-Treatment Procedure

After the ink was applied, the fabric was dried at room temperature and steamed at 102° C. for 8 minutes to fix the dye. The fabric was then washed to remove unreacted dye using soft water and washing equipment with multiple wash tanks, as follows. With 5 g/l Burco Quest FCA (anionic chelating agent from Burlington Chemical) and 10 g/l sodium carbonate added to the tank, the fabric was washed cold (20° C.) for 5 minutes. The temperature was then adjusted to 75-80° C. and the fabric washed for another five minutes. For dark colors, 5 g/l Burco Scour SBO 300 (anionic detergent from Burlington Chemical) was added during the hot wash. The fabric was then rinsed cold and dried with a Stenter frame.

### Examples 1-15

As shown in the following tables, the inventive examples containing PPG 1000 demonstrate superior shade depth relative to the associated comparative examples (designated with a “-C” after the number) containing PEG 4600 as the viscosity agent. The inks were coated by hand onto the pre-treated cotton fabric. The fabric was placed on a smooth glass plate and 1 gram of ink was applied using an 8 micron wire-wound rod.

After steaming, the fabric was washed in 1000 grams of water and the optical density of the wash off solution was determined using a UV-Vis spectrophotometer. Lower optical density of the wash off solution indicates higher fixation of the dye on the fabric.

| Example: | 1 | 1-C | 2 | 2-C | 3 | 3-C | 4 | 4-C |
|---|---|---|---|---|---|---|---|---|
| Water | 30 | 30 | 30 | 30 | 30 | 30 | 30 | 30 |
| Jettex ® Blue 3R | 5 | 5 | 5 | 5 | 5 | 5 | 5 | 5 |
| Dowanol ™ | 10 | 10 | — | — | — | — | — | — |
| DPM | | | | | | | | |
| Dowanol ™ | — | — | 10 | 10 | — | — | — | — |
| TPM | | | | | | | | |
| Dowanol ™ | — | — | — | — | 10 | 10 | — | — |
| DMM | | | | | | | | |
| Dowanol ™ | — | — | — | — | — | — | 10 | 10 |
| PnP | | | | | | | | |
| PEG 4600 | — | 5 | — | 5 | — | 5 | — | 5 |
| PPG1000 | 5 | — | 5 | — | 5 | — | 5 | — |
| Total grams: | 50 | 50 | 50 | 50 | 50 | 50 | 50 | 50 |
| K/S | 23 | 11.8 | 22.7 | 12.6 | 21.7 | 8.8 | 20.7 | 8.9 |

| Example: | 5-C | 5 | 6-C | 6 | 7-C | 7 | 8-C | 8 |
|---|---|---|---|---|---|---|---|---|
| Water | 25 | 25 | 25 | 25 | 25 | 25 | 25 | 25 |
| Jettex ® Blue 3R | 5 | 5 | — | — | — | — | — | — |
| Fourcolor Blue | — | — | 5 | 5 | — | — | — | — |
| P-BR | | | | | | | | |
| Cibacron ® | — | — | — | — | 5 | 5 | — | — |
| Blue P-6B | | | | | | | | |
| Procion ® | — | — | — | — | — | — | 5 | 5 |
| Blue H-EXL | | | | | | | | |
| Diethylene glycol | 15 | — | 15 | — | 15 | — | 15 | — |
| Butyl carbitol | — | 15 | — | 15 | — | 15 | — | 15 |
| PEG4600 | 5 | — | 5 | — | 5 | — | 5 | — |
| PPG1000 | — | 5 | — | 5 | — | 5 | — | 5 |
| Total grams: | 50 | 50 | 50 | 50 | 50 | 50 | 50 | 50 |
| K/S | 3.1 | 22 | 2.0 | 17.4 | 5.3 | 24.6 | 19.4 | 26.1 |

| Example: | 9-C | 9 | 10-C | 10 | 11-C | 11 | 12-C | 12 | 13-C | 13 | 14-C | 14 | 15-C | 15 |
|---|---|---|---|---|---|---|---|---|---|---|---|---|---|---|
| Water | 25 | 25 | 25 | 25 | 5 | 5 | 5 | 5 | 25 | 25 | 25 | 25 | 25 | 25 |
| Jettex ® Black GR | 5 | 5 | — | — | — | — | — | — | — | — | — | — | — | — |
| Cibacron ® Black D-GR | — | — | 5 | 5 | — | — | — | — | — | — | — | — | — | — |
| Procion ® Black PX-2 | — | — | — | — | 25 | 25 | — | — | — | — | — | — | — | — |
| Avecia Black GR | — | — | — | — | — | — | 30 | 30 | — | — | — | — | — | — |
| Procion ® Blue XL+ | — | — | — | — | — | — | — | — | 5 | 5 | — | — | — | |
| Procion ® Dark Blue XL+ | — | — | — | — | — | — | — | — | — | — | 5 | 5 | — | — |
| Procion ® Navy Blue XL+ | — | — | — | — | — | — | — | — | — | — | — | — | 5 | 5 |
| Diethylene glycol | 15 | — | 15 | — | 15 | — | 15 | — | 15 | — | 15 | — | 15 | — |
| Dowanol ™ DPM | — | 15 | — | 15 | — | 15 | — | 15 | — | 15 | — | 15 | — | 15 |
| PEG4600 | 5 | — | 5 | — | 5 | — | 5 | — | 5 | — | 5 | — | 5 | — |
| PPG1000 | — | 5 | — | 5 | — | 5 | — | 5 | — | 5 | — | 5 | — | 5 |
| Total grams: | 50 | 50 | 50 | 50 | 50 | 50 | 55 | 55 | 50 | 50 | 50 | 50 | 50 | 50 |
| K/S at 400 nm | 8.8 | 23.5 | 10.9 | 23.6 | 10.3 | 24.3 | 16.0 | 25.8 | — | — | — | — | — | — |
| K/S at abs. Max. | — | — | — | — | — | — | — | — | 18.7 | 22.1 | 21.6 | 28.0 | 22.3 | 25.4 |
| Wash off OD | 1.79 | 1.60 | — | — | 2.3 | 1.4 | 2.86 | 1.33 | 2.04 | 1.75 | 0.839 | 0.153 | 1.733 | 0.808 |

### Example 16

The following table provides a comparison of PEG/PPG copolymers as viscosity agent versus PPG 1000. The inventive example with PPG again provides better shade depth.

| Example: | 16 | 16-C1 | 16-C2 |
|---|---|---|---|
| Water | 33 | — | — |
| Jettex ® Blue 3R | 5 | 5 | 5 |
| Dowanol ™ DPM | 5 | 5 | 5 |
| 20% solution of PEG/PPG Copolymer Mw | — | 40 | — |
| 8400 | | | |
| 10% solution of PEG/PPG Copolymer Mw | — | — | 40 |
| 12000 | | | |
| PPG1000 | 5 | — | — |
| Total grams: | 48 | 50 | 50 |
| K/S | 20.2 | 6.5 | 12.6 |

### Example 17

The following table provides a comparison of polyvinylpyrrolidone and polyacrylamide as viscosity agent versus PPG 425. The inventive example with PPG again provides better shade depth.

| Example: | 17 | 17-C1 | 17-C2 |
|---|---|---|---|
| Cibacron ™ Blue P-3R | 5 | 5 | 50 |
| Water | 25 | 25 | 269.5 |
| Dowanol ™ DPM | 5 | 5 | — |
| Diethylene glycol | — | — | 150 |
| PPG425 | 15.7 | — | — |
| Polyvinylpyrrolidone Mn 10,000 | — | 5 | — |
| Polyacrylamide Mn 10,000 | | | 37.5 |
| Morpholineethanesulfonic acid | — | — | 3 |
| Total grams | 50.7 | 40 | 510 |
| K/S | 22 | 13 | 7.8 |
| Wash off OD | 0.80 | 1.73 | — |

### Examples 18 and 19

The following table provides inventive examples comparing of PPG425 and PPG1000 as viscosity agent. Both give similar high values for shade depth.

| Example: | 18 | 19 |
|---|---|---|
| Jettex ® Blue 3R | 5 | 5 |
| Water | 35 | 25 |
| Dowanol ™ DPM | 5 | 5 |
| PPG425 | — | 15 |
| PPG1000 | 5 | — |
| Total grams | 50 | 50 |
| K/S | 20.8 | 20.1 |

### Example 20

These examples were printed on the test fabric with a Spectra Nova AQ printhead (Spectra Inc., Hanover, N.H. USA) (100% coverage is about 18 grams/m2, wet weight).

Ink with PPG 425 is compared to ink with PEG 4600, PEG 900 and PEG 600. Results again show the same relative shade depth benefits of the inventive example versus the comparative examples.

| Example: | 20 | 20-C1 | 20-C2 | 20-C3 | 20-C4 | 20-C5 |
|---|---|---|---|---|---|---|
| Water | 250 | 255 | 250 | 250 | 250 | 250 |
| Jettex ® | 50 | 50 | 40 | 40 | 40 | 40 |
| Blue 3R | | | | | | |
| Dowanol ™ | 50 | — | 20 | — | 20 | — |
| DPM | | | | | | |
| Diethylene | — | 150 | — | — | — | — |
| glycol | | | | | | |
| PPG 425 | 150 | — | — | — | — | — |
| PEG 4600 | — | 38 | — | — | | — |
| PEG 900 | — | — | 139 | 140 | — | — |
| PEG 600 | — | — | — | — | 160 | 160 |
| 2-Pyrrolidone | — | — | — | 20 | — | 20 |
| Proxel GXL | — | 1 | — | — | — | — |
| Total grams: | 500 | 493 | 449 | 450 | 470 | 470 |
| Viscosity (cps) | 14.0 | 14.1 | 14.1 | 13.8 | 12.4 | 11.7 |
| K/S | 10.01 | 3.8 | 0.7 | 0.73 | 0.71 | 0.62 |

### Examples 21-23

These examples were printed on the test fabric with a Spectra Nova AQ printhead (100% coverage is about 18 grams/m2, wet weight).

Ink with PPG 1000 is compared to ink with PEG 4600. Results again show the same relative shade depth benefits of the inventive example versus the comparative examples.

| Example: | 21 | 21-C | 22 | 22-C | 23 | 23-C |
|---|---|---|---|---|---|---|
| Water | 201.5 | 228.5 | 191.5 | 222.5 | 219 | 238.5 |
| Jettex ® | 50 | 50 | 50 | 50 | 50 | 50 |
| Blue 3R | | | | | | |
| Dowanol ™ | 150 | 150 | 150 | 150 | — | — |
| DPM | | | | | | |
| Butyl Carbitol | — | — | — | — | 150 | — |
| DEG | — | — | — | — | — | 150 |
| PEG 4600 | — | 43 | — | 46 | — | 55 |
| PPG 1000 | 70 | — | 80 | — | 50 | — |
| Glycerol | 25 | 25 | 25 | 25 | 25 | — |
| MOPS | 2.5 | 2.5 | 2.5 | 2.5 | 0 | 2.5 |
| Surfynol ® | — | — | — | — | 5 | 3 |
| 440 | | | | | | |
| Proxel GXL | 1 | 1 | 1 | 1 | 1 | 1 |
| Total grams: | 500 | 500 | 500 | 500 | 500 | 500 |
| Viscosity (cps) | 13.0 | 15.7 | 15.2 | 16.2 | 13.3 | 14.9 |
| K/S | 6.94 | 4.04 | 7.36 | 3.70 | 7.25 | 2.50 |

MOPS is 4-morpholinepropanessulfonic acid, sodium salt

Surfynol® 440 is a surfactant (Air Products and Chemicals, Inc, Allentown Pa., USA).

We claim:

1. An inkjet ink composition having a desired viscosity up to about 30 cps at 25° C., said inkjet ink comprising a soluble colorant, at least about 40% water (based on the total weight of the ink), and a polypropylene glycol of number average molecular weight (Mn) in the range of about 425 to less than 2000, wherein the amount of said polypropylene glycol in said inkjet ink is effective to impart said desired viscosity.

2. The inkjet ink composition of claim 1, wherein polypropylene glycol is present in the ink at about 5% by weight or more, based upon the total ink weight.

3. The inkjet ink composition of claim 1, wherein the polypropylene glycol has a number average molecular weight (Mn) in the range of about 425 to about 1000.

4. The inkjet ink composition of claim 1, further comprising one or more co-solvents.

5. The inkjet ink composition of claim 4, wherein the co-solvent is selected from mono-, di- and tri-ethylene glycol; mono-, di- and tri-propylene glycol; mono- and di-C₁-C₄-alkyl ethers of the foregoing glycols; glycerol; 2-pyrrolidone; N-methyl pyrrolidone.

6. The inkjet ink composition of claim 1, wherein the viscosity is in the range of about 8 to about 20 cps at 25° C.

7. The inkjet ink composition of claim 1, wherein the soluble colorant is one or more reactive dye(s).

8. The inkjet ink composition of claim 7, wherein at least one of the one or more reactive dye(s) is selected from the group consisting of monochlorotriazines, dichlorotriazines and vinylsulfones.

9. The inkjet ink of claim 2, further comprising one or more co-solvents, and wherein the polypropylene glycol has a number average molecular weight (Mn) in the range of about 425 to about 1000, the viscosity is in the range of about 8 to about 20 cps at 25° C., and the soluble colorant is one or more reactive dye(s).

10. A method of inkjet printing comprising the step of printing a textile substrate with an inkjet printer by jetting one or more inkjet inks via said inkjet printer onto said textile substrate, wherein at least one of said one or more inkjet inks is an inkjet ink composition having a desired viscosity up to about 30 cps at 25° C., said inkjet ink composition comprising a soluble colorant, at least about 40% water (based on the total weight of the ink), and a polypropylene glycol of number average molecular weight (Mn) in the range of about 425 to less than 2000, wherein the amount of said polypropylene glycol in said inkjet ink is effective to impart said desired viscosity.

11. The method of claim 10, wherein polypropylene glycol is present in the ink at about 5% by weight or more, based upon the total ink weight.

12. The method of claim 10, wherein the polypropylene glycol has a number average molecular weight (Mn) in the range of about 425 to about 1000.

13. The method of claim 10, further comprising one or more co-solvents.

14. The method of claim 13, wherein the co-solvent is selected from mono-, di- and tri-ethylene glycol; mono-, di- and tri-propylene glycol; mono- and di-C₁-C₄-alkyl ethers of the foregoing glycols; glycerol; 2-pyrrolidone; N-methyl pyrrolidone.

15. The method of claim 10, wherein the viscosity is in the range of about 8 to about 20 cps at 25° C.

16. The method of claim 10, wherein the soluble colorant is one or more reactive dye(s).

17. The method of claim 16, wherein at least one of the one or more reactive dye(s) is selected from the group consisting of monochlorotriazines, dichlorotriazines and vinylsulfones.

18. The method of claim 11, further comprising one or more co-solvents, and wherein the polypropylene glycol has a number average molecular weight (Mn) in the range of about 425 to about 1000, the viscosity is in the range of about 8 to about 20 cps at 25° C., and the soluble colorant is one or more reactive dye(s).
